(19) United States
(12) Patent Application Publication
(10) Pub. No.: US 2007/0290602 A1
(43) Pub. Date: Dec. 20, 2007

(54) Image display device and manufacturing method of the same

(76) Inventors: Nobuhiko Hosotani, Mobara (JP); Shigemi Hirasawa, Chiba (JP); Yuuichi Kijima, Chosei (JP); Tomohiro Moriyama, Hitachi (JP); Takashi Naito, Funabashi (JP)

Correspondence Address: REED SMITH LLP, Suite 1400, 3110 Fairview Park Drive, Falls Church, VA, 22042, US

(21) Appl. No.: 11/806,390

(22) Filed: May 31, 2007

(30) Foreign Application Priority Data
Jun. 2, 2006 (JP) 2006-154304
May 25, 2007 (JP) 2007-138668

(51) Int. Cl. H01J 63/04

(52) U.S. Cl. 313/497

(57) ABSTRACT

The present invention provides a planar image display device which can prevent the generation of discharge by attenuating the concentration of an electric field on an end surface of a high voltage applied portion of a phosphor screen. In a planar image display device which includes a back substrate having a plurality of signal lines and a plurality of electron sources on a glass substrate, a face substrate having a phosphor screen layer, a BM film and a metal back on a glass substrate, and a frame body interposed between the back substrate and the face substrate, a high resistance film is arranged to cover a periphery of the metal back.

### BACKGROUND OF THE INVENTION

1. Field of the Invention

The present invention relates to a self-luminous flat-panel-type image display device, and more particularly to an image display device which arranges thin-film-type electron sources in a matrix array.

2. Description of the Related Art

As one self-luminous flat-panel-type image display (FPD) having electron sources which are arranged in a matrix array, an electric field emission type image display device (FED: Field Emission Display) which uses minute integrative cold cathodes and an electron emission type image display device have been known. As the cold cathode, there have been known a electron source such as a Spindt-type electron source, a surface-conducive-type electron source, a carbon-nanotube-type electron source, an MIM (Metal-Insulator-Metal) type electron source which is formed by stacking a metal layer, an insulator and a metal layer in this order, an MIS (metal-insulator-semiconductor) type electron source which is formed by stacking a metal layer, an insulator and a semiconductor in this order or a metal-insulator-semiconductor-metal type electron source.

The generally-used self-luminous-type FPD includes a back panel which arranges the above-mentioned electron sources on a back substrate formed of a glass plate, a face panel which arranges phosphor layers and an anode which forms an electric field for allowing electrons emitted from the electron sources to impinge on the phosphor layers on a face substrate formed of a glass plate and a frame body which holds an inner space defined between both facing panels into a predetermined distance, wherein the FPD is configured to hold a display space which is defined by both panels and the frame body into a vacuum state. The FPD is constituted by combining a drive circuit with the display panel.

Further, on the back substrate of the back panel, a plurality of scanning signal lines which extends in one direction and is arranged in parallel in the other direction orthogonal to the one direction and to which scanning signals are sequentially applied in the other direction is arranged and, further, on the back substrate, a plurality of video signal lines which extends in the other direction and is arranged in parallel in the one direction to intersect the scanning signal lines is arranged. Further, in general, the electron sources are arranged in the vicinity of respective intersecting portions of the scanning signal lines and the video signal lines, the scanning signal lines and the electron sources are connected to each other by power supply electrodes, and a current is supplied to the electron sources from the scanning signal lines.

Further, the individual electron source forms a pair with the corresponding phosphor layer so as to constitute a unit pixel. Usually, one pixel (color pixel) is constituted of the unit pixels of three colors consisting of red (R), green (G) and blue (B). Here, in the case of the color pixel, the unit pixel is also referred to as a sub pixel.

In addition to the above-mentioned constitution, in the image display device as described above, in the inside of a display region which is defined by the frame body arranged between the back substrate and the face substrate, a plurality of distance holding members (hereinafter referred to as spacers) is arranged and fixed. The distance between the above-mentioned both substrates is held at a predetermined distance in cooperation with the frame body. The spacers are formed of a plate-like body made of an insulating material such as glass, ceramics, or a material having some conductivity in general. Usually, the spacers are arranged at positions which do not impede an operation of pixels for every plurality of pixels.

Further, the frame body which constitutes a sealing frame is fixed to respective inner peripheries between the back substrate and the face substrate using a sealing material such as frit glass, and the fixing portions are hermetically sealed thus forming sealing regions. The degree of vacuum in the inside of a display region defined by both substrates and the frame body is set to 10⁻⁵ to 10⁻⁷ Torr, for example.

Scanning-signal-line lead terminals which are connected to the scanning signal lines formed on the back substrate and video-signal-line lead terminals which are connected to the video signal lines formed on the back substrate respectively penetrate the sealing regions defined between the frame body and both substrates.

[Patent Document 1] JP-A-2002-75254

[Patent Document 2] JP-A-2002-100313

[Patent Document 3] JP-A-2004-363075

### SUMMARY OF THE INVENTION

With respect to the above-mentioned self-luminous image display device, patent document 1 discloses the constitution which mounts electrodes on surfaces of the frame body which are brought into contact with both substrates and, at the same time, arranges a high resistance film on side surfaces of side walls which abut the contact surfaces. Further, patent document 2 discloses the constitution which sequentially arranges two kinds of resistance films having different resistance values from each other outside a display region for preventing discharge.

In this type of image display device, it is inevitably necessary to adopt a measure to cope with the discharge. However, conventionally, such a measure has the possibility of smearing or damaging inner surfaces of both substrates including the display region which may give rise to drawbacks that a display quality is deteriorated and a prolonged lifetime is hardly obtainable.

The present invention has been made to overcome the above-mentioned drawbacks and it is an object of the present invention to provide an image display device of a prolonged lifetime which can exhibit excellent display quality.

To achieve the above-mentioned object, the image display device of the present invention is characterized in that the image display device includes a high-resistance film which extends in the direction toward a frame body while being in contact with a periphery of an acceleration electrode mounted on a face substrate and is arranged to be spaced apart from the frame body with a predetermined distance therebetween.

Further, the image display device of the present invention is characterized in that, in addition to the high-resistance film which is formed contiguously with the acceleration electrode, a second high-resistance film is arranged on an inner side surface of the frame body.

Still further, the image display device of the present invention is characterized in that, in the formation of the high-resistance film, a method for forming the high-resistance film optimum for a material for forming the high-resistance film is used.

By arranging the high-resistance film in contact with the periphery of the acceleration electrode, the high-resistance film constitutes a high-voltage-potential attenuating layer and hence, the concentration of an electric field on an end surface of a high-voltage applied portion of a phosphor screen is attenuated whereby the generation of discharge can be suppressed thus realizing an image display device of a prolonged lifetime which exhibits excellent display quality.

Further, by arranging the second high-resistance film on an inner side surface of the frame body, it is possible to further suppress the generation of discharge thus realizing an image display device of a prolonged lifetime which exhibits excellent display quality.

Still further, by arranging the single high-resistance film in a state that the high-resistance film covers the whole circumference of a periphery of the acceleration electrode, operation steps can be simplified, the generation of smears and damages on the phosphor screen can be suppressed thus realizing an image display device of a prolonged lifetime which exhibits excellent display quality.

Still further, by using the method for forming the high-resistance film optimum for the material for forming the high-resistance film, it is possible to efficiently form the film which exhibits the excellent property at an extremely low cost.

### BRIEF DESCRIPTION OF THE DRAWING

FIG. 1A and FIG. 1B are schematic views for explaining a first embodiment of an image display device according to the present invention, wherein FIG. 1A is a plan view as viewed from a face substrate side and FIG. 1B is a side view of FIG. 1A;

FIG. 2 is a schematic plan view taken along a line A-A in FIG. 1B;

FIG. 3 is a schematic cross-sectional view taken along a line B-B in FIG. 1A;

FIG. 4 is a schematic cross-sectional view taken along a line C-C in FIG. 1A;

FIG. 5 is a schematic view for explaining electric field distributions;

FIG. 6 is a schematic cross-sectional view for explaining another embodiment of the image display device according to the present invention;

FIG. 7 is a schematic plan view for explaining still another embodiment of the image display device according to the present invention; and

FIG. 8 is a schematic cross-sectional view for explaining still another embodiment of the image display device according to the present invention.

### DESCRIPTION OF THE PREFERRED EMBODIMENTS

Hereinafter, the present invention is explained in detail in conjunction with drawings of embodiments.

### Embodiment 1

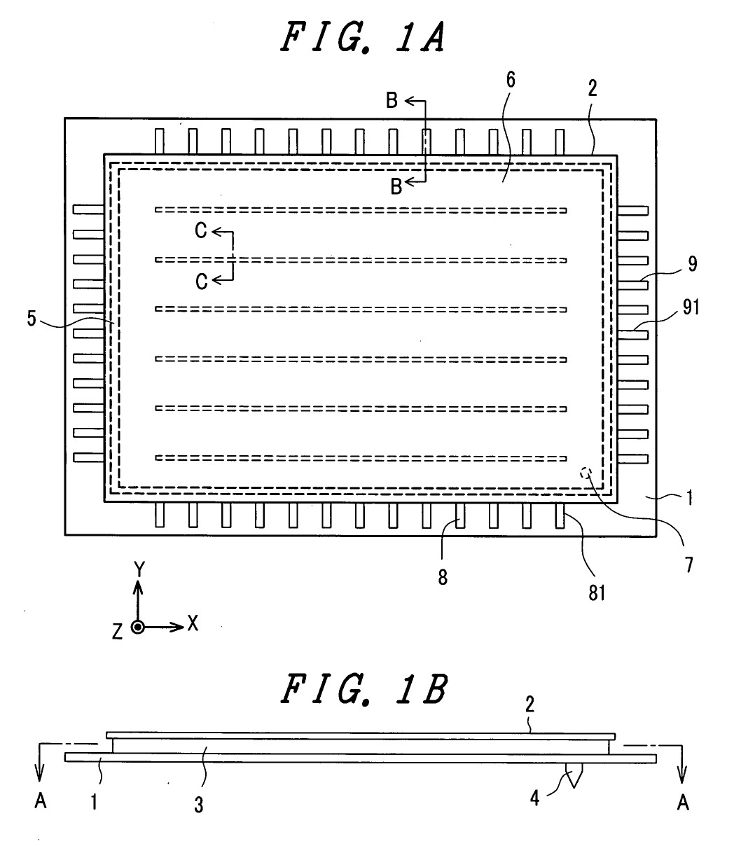

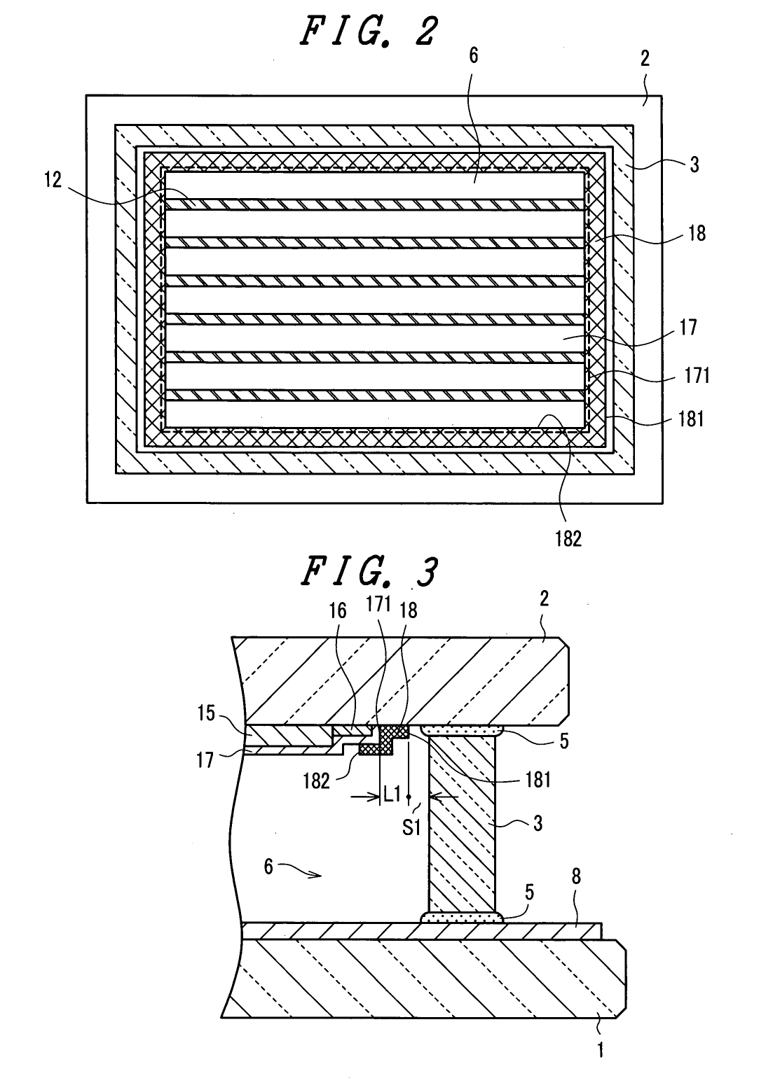

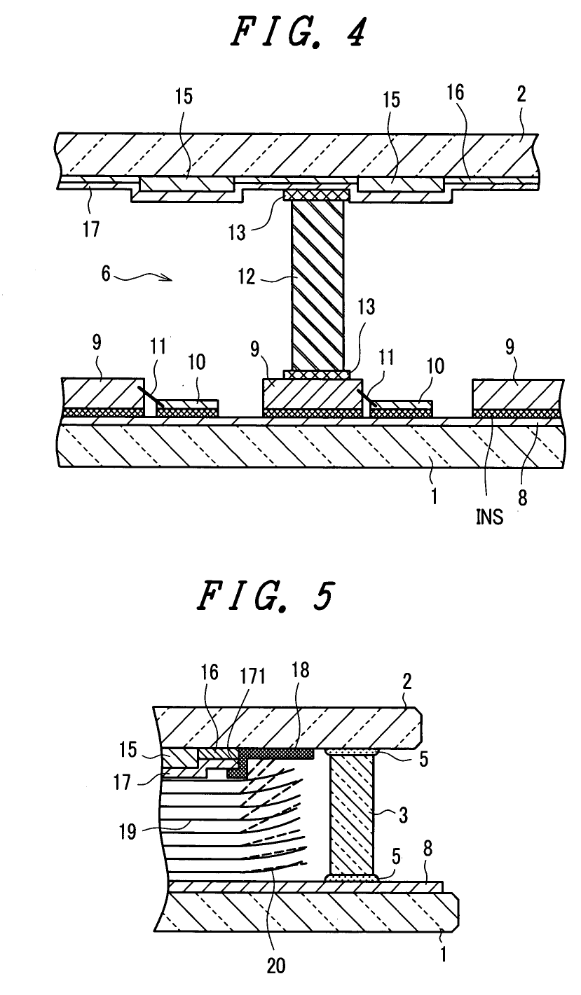

FIG. 1A to FIG. 4 are schematic views for explaining a first embodiment of an image display device according to the present invention, wherein FIG. 1A is a plan view as viewed from a face substrate side, FIG. 1B is a side view of FIG. 1A, FIG. 2 is a plan view taken along a line A-A in FIG. 1B, FIG. 3 is a cross-sectional view taken along a line B-B in FIG. 1A, FIG. 4 is a cross-sectional view taken along a line C-C in FIG. 1A.

In FIG. 1A to FIG. 4, numeral 1 indicates aback substrate, numeral 2 indicates a face substrate, numeral 3 indicates a frame body, numeral 4 indicates a discharge pipe, numeral 5 indicates a sealing member, numeral 6 indicates a space, numeral 7 indicates a through hole, numeral 8 indicates a video signal line, numeral 9 indicates a scanning signal line, numeral 10 indicates an electron source, numeral 11 indicates a connection electrode, numeral 12 indicates a spacer, numeral 13 indicates an adhesive material, numeral 15 indicates a phosphor layer, numeral 16 indicates a BM (black matrix) film for blocking light, numeral 17 indicates a metal back (acceleration electrode) formed of a thin metal film, and numeral 18 indicates a high-resistance film.

Both substrates 1, 2 are formed of a glass plate having a thickness of several mm, for example, approximately 1 to 10 mm. Both substrates are formed in a substantially rectangular shape. The back substrate 1 and the face substrate 2 are arranged with a predetermined distance therebetween. Numeral 3 indicates a frame body which exhibits a frame shape. The frame body 3 is made of, for example, a frit glass sintered body, a glass plate or the like. The frame body 3 is formed into a substantially rectangular shape using a single body or a combination of a plurality of members and is interposed between both substrates 1, 2.

Further, the frame body 3 is interposed between peripheral portions of both substrates 1, 2, and both end surfaces of the frame body 3 are hermetically joined to both substrates 1, 2. A thickness of the frame body 3 is set to a value which falls within a range from several mm to several ten mm, and a height of the frame body 3 is set to a value substantially equal to a distance between both substrates 1, 2. Numeral 4 indicates a discharge pipe which is fixedly secured to the back substrate 1. Numeral 5 indicates a sealing material. The sealing material 5 is made of frit glass, for example, and joins the frame body 3 and both substrates 1, 2 thus hermetically sealing a space defined by the frame body 3 and both substrates 1, 2.

A space 6 which is a space surrounded by the frame body 3, both substrates 1, 2 and the sealing material 5 is evacuated through the discharge pipe 4 so as to hold a degree of vacuum of, for example, 10⁻⁵ to 10⁻⁷ Torr in the space 6. Further, the discharge pipe 4 is mounted on an outer surface of the back substrate 1 as mentioned previously and is communicated with a through hole 7 which is formed in the back substrate 1 in a penetrating manner. After completing the evacuation, the discharge pipe 4 is sealed.

Numeral 8 indicates video signal lines. The video signal lines 8 are formed of a metal material as described later, and the video signal lines 8 extend in one direction (Y direction) and are arranged in parallel in the other direction (X direction) on an inner surface of the back substrate 1. The video signal lines 8 hermetically penetrate a sealing region between the frame body 3 and the back substrate 1 from the space 6 and extend to an end surface of the back substrate 1. The video signal lines 8 have distal end portions thereof disposed outside the sealing region thus forming video-signal-line lead terminals 81.

Numeral 9 indicates scanning signal lines. The scanning signal lines 9 are formed of a metal material as described later, and the scanning signal lines 9 extend over the video signal lines 8 in the other direction (X direction) which intersects the video signal lines 8 and are arranged in parallel to the above-mentioned one direction (Y direction). The scanning signal lines 9 hermetically penetrate a sealing region formed between the frame body 3 and the back substrate 1 from the space 6 and extend to the vicinity of an end surface of the back substrate 1. The scanning signal lines 9 have distal end portions thereof disposed outside the sealing region thus forming scanning-signal-line lead terminals 91.

Numeral 10 indicates MIM-type electron sources which form one kind of electron sources disclosed in patent document 3, for example. The electron sources 10 are formed in the vicinity of respective intersecting portions of the scanning signal lines 9 and the video signal lines 8. Further, the electron sources 10 are connected to the scanning signal lines 9 via connection electrode 11. Further, an interlayer insulation film INS is arranged between the video signal lines 8 and the scanning signal lines 9.

Here, the video signal lines 8 are formed of an Al (aluminum) film, for example, while the scanning signal lines 9 are formed of a Cr/Al/Cr film, a Cr/Cu/Cr film or the like, for example. Further, although the above-mentioned line lead terminals 81, 91 are respectively provided to both ends of the signal lines 8, 9, the line lead terminals 81, 91 may be provided to only either one of these ends.

Next, numeral 12 indicates spacers, wherein the spacers 12 are formed of a plate-shaped body which is made of an insulation material such as a glass material or a ceramic material, or a member which has some conductivity. The spacers 12 are usually arranged at positions where the spacers 12 do not impede operations of pixels for every plurality of other pixels. The spacers 12 possess a specific resistance of approximately 10⁸ to 10⁹Ω·cm and exhibit the small non-uniform distribution of a resistance value thereof as a whole. The spacers 12 are arranged on the scanning signal lines 9 in substantially parallel to the frame body 3 every other line in a vertical manner and are fixed by adhesion to both substrates 1, 2 using an adhesive material 13. Further, the fixing of the spacer 12 to the substrates by adhesion may be performed only on one end side of the spacer 12. The spacers 12 are usually arranged at positions which do not impede operations of pixels for every plurality of other pixels. Further, it is also possible to arrange the spacers 12 on the scanning signal lines 9 every several other lines.

Sizes of the spacers 12 are set based on sizes of substrates, a height of the frame body, materials of the substrates, an arrangement interval of the spacers, a material of spacers or the like. However, in general, the height of the spacers is approximately equal to a height of the above-mentioned frame body, and a thickness of the spacers 12 is set to several 10 μm to several mm or less. A length of the spacers 12 is set to approximately 20 mm to 1000 mm. Although the length of the spacers 12 may be set to a value equal to or more than 1000 mm, it is preferable to set the length of the spacers 12 to a value which falls within a range from approximately 80 mm to 300 mma in view of a practical use of the spacers 12.

On an inner surface of the face substrate 2 to which one end sides of the spacers 12 are fixed, phosphor layers 15 of red, green and blue are arranged in a state that these phosphor layers 15 are arranged in window portions defined by a light-blocking BM (black matrix) film 16. A metal back (acceleration electrode) 17 made of a thin metal film is formed by a vapor deposition method, for example, to cover the phosphor layers 15 and the BM film 16 thus forming a phosphor screen. During an operation, an anode voltage of approximately 3 kV to 20 kV is applied to the phosphor screen. The metal back 17 performs a function of a light reflection film which enhances an takeout efficiency of emitted light by directing and reflecting light which is emitted in the direction toward a side opposite to the face substrate 2, that is, toward the back substrate 1 side, toward the face substrate 2 side and also performs a function of preventing surfaces of phosphor particles from being charged.

Further, with respect to these phosphors, for example, Y₂O₃: Eu, Y₂O₂S: Eu may be used as a material for the red phosphor, ZnS:Cu, Al, Y₂SiO₅:Tb may be used as a material for the green phosphor, and ZnS:Ag, Cl, ZnS:Ag, Al may be used as a material for the blue phosphor. With respect to the phosphor layers 15, an average particle diameter of the phosphor particles is set to 4 μm to 9 μm, for example, and a film thickness of the phosphor layers 15 is set to 10 μm to 20 μm, for example.

Next, a high-resistance film indicated by numeral 18 covers the whole circumference of a periphery 171 of the metal back 17, extends toward the frame body 3 and has a trailing end 181 thereof arranged to be spaced apart from the frame body 3 in a non-contacted manner with a fixed distance S1 therebetween. On the other hand, a leading end 182 of the high-resistance film 18 is, as mentioned above, arranged to overlap and cover the whole circumference of the periphery 171 of the metal back 17 and functions as a high-voltage potential attenuating layer.

The high-resistance film 18 covers the periphery 171 of the metal back 17 and extends toward the frame body 3, wherein it is necessary to set a length L1 between the periphery 171 of the metal back 17 and the tracing end 181 of the high-resistance film 18 to approximately 3 mm to 10 mm. When the length L1 is less than 3 mm, a high voltage potential attenuating effect cannot be expected, while when the length L1 exceeds 10 mm, the display region is narrowed and the peripheral region thereof is widened. It is preferable to set the length L1 to approximately 4 mm to 8 mm. Further, it is necessary to set a film thickness of the high resistance film 18 to 3 μm to 20 μm, and more preferably to 5 μm to 10 μm. When the film thickness is less than 3 mm, there is a possibility that the film disappears, while when the film thickness exceeds 20 μm, the high voltage potential attenuating effect cannot be expected.

The high-resistance film 18 is constituted of insulating high-resistance oxide such as iron oxide and chromium oxide, and an inorganic binder such as water glass. As the iron oxide, for example, the use of Fe₂O₃ which has been actually used in a cathode ray tube or the like is recommendable, while as the chromium oxide, for example, the use of Cr₂O₃ is recommendable. In such a constitution, iron oxide, chromium oxide or the like having a particle size of 0.1 μm to 10 μm is used. Particularly, when the particle size exceeds 10 μm, there arises a drawback that the potential attenuation effect is small. Accordingly, the particle size is preferably set to a value which falls within a range approximately from 0.5 μm to 3 μm.

When water glass which has been actually used in cathode ray tubes or the like is used as inorganic binder of the high-resistance film 18, 1 weight % to 20 weight % of water glass is used, and it is preferable to use approximately 3 weight % to 10 weight % of water glass. Further, when water glass and Fe₂O₃ are used in combination or when water glass and Cr₂O₃ are used in combination, it is preferable to set a mixing ratio to 1:4 to 1:10 with respect to water glass: Fe₂O₃ and to 1:4 to 1:10 with respect to water glass: Cr₂O₃.

The high-resistance film 18 is formed such that a mixed solution made of the above-mentioned material is applied to a portion where the high-resistance film 18 is to be formed using a known jig such as a sponge, a blush or a pen by coating and is dried thus completing the high-resistance film 18. A resistance value of the high-resistance film 18 after completion is 10¹⁰Ω/□ to 10¹⁴Ω/□ thus forming a high-resistance film which remarkably differs in resistance value from a phosphor screen which forms the metal back 17 thereon and exhibits a resistance value of 1 mΩ/□ to 10²Ω/□.

The high-resistance film 18 may be, besides the above-mentioned combination of the insulating high-resistance oxide such as iron oxide or chromium oxide and the inorganic binder such as water glass, formed of a conductive frit glass film, a sputter film of transitional metal oxide, a sputter film made of the combination of transitional metal and oxygen, or an extension of a BM film.

In forming the high-resistance film 18 using the conductive frit glass film, conductive frit glass which contains glass powder mainly constituted of vanadium oxide is used. The high-resistance film 18 may be formed by a method which sprays a glass paste and bakes the sprayed glass paste.

The conductive frit glass may preferably have the composition which contains phosphorous oxide, antimony oxide, valium oxide or the like in addition to vanadium oxide and, further, contains silicon oxide or aluminum oxide as a filler.

In terms of the composition, the conductive frit glass may be constituted of 40 wt % to 45 wt % of vanadium oxide, 15 wt % to 25 wt % of phosphorous oxide, 5 wt % to 20 wt % of antimony oxide, and 5 wt % to 20 wt % of valium oxide.

On the other hand, since the filler possesses a resistance value adjusting function, along with the increase of a filler content, the resistance value of the high-resistance film 18 is increased. An optimum filler content is 10 wt % to 20 wt % of the glass paste.

In the constitution of the high-resistance film 18 using such conductive frit glass, the surface irregularities of the film is required to have an average roughness Ra of 0.1 μm to 5 μm, and particularly preferable to have the average roughness Ra of 1 μm to 3 μm. When the average roughness Ra is less than 0.1 μm, there exists a possibility that a high voltage potential attenuation effect cannot be expected, while when the average roughness Ra exceeds 5 μm, there exists a possibility that a foreign substance is generated due to chipping and, it is desirable to set the average roughness Ra to a value which falls within a range from 0.1 μm to 5 μm as mentioned above.

The resistance value of the high-resistance film 18 is 10¹⁰Ω/□ to 10¹⁴Ω/□ after a heating step of the panel thus forming the high-resistance film 18 which remarkably differs in resistance value from the phosphor screen which forms the metal back 17 thereon and exhibits the resistance value of 1 mΩ/□ to 10²Ω/□.

On the other hand, in the constitution of the high-resistance film 18 which is formed of the sputter film made of transitional metal oxide or a reactive sputter film formed of the combination of the transitional metal and oxygen, a target made of iron oxide (Fe₂O₃), chromium oxide (Cr₂O₃) or the like, for example, is used, and the high-resistance film 18 is formed by sputtering.

A film thickness of the high-resistance film 18 is set to approximately 20 nm to 400 nm, and the resistance value of the high-resistance film 18 is set to 10¹⁰Ω/□ to 10¹⁴Ω/□ after the heating step of the panel thus forming a high-resistance film which possesses the resistance value remarkably different from 1 mΩ/□ to 10²Ω/□ of the resistance value of the phosphor screen formed on the metal back 17.

Further, in the constitution of the high-resistance film 18 formed by the extension of the BM film, the BM film has a stacked structure formed of chromium oxide and chromium, wherein a film forming range of chromium oxide on a lower side, that is, a panel surface side is set larger than a film forming range of chromium on the upper side by approximately 4 mm to 8 mm, for example thus forming an exposed chromium oxide film region as an electric field attenuation layer.

As one example of film thicknesses, the high-resistance film 18 may adopt the structure in which a thickness of the chromium oxide film is approximately 40 nm and the thickness of chromium film is approximately 200 nm.

The resistance value of the high-resistance film 18 is 10¹⁰Ω/□ to 10¹⁴Ω/□ after a heating step of the panel, and the high-resistance film 18 exhibits the resistance value of 10 ¹⁰Ω/□ to 10¹⁴Ω/□ which remarkably differs from 1 mΩ/□ to 10²Ω/□ of the resistance value of the phosphor screen on which the metal back 17 is formed.

FIG. 5 is a view which schematically shows the distribution of an electric field in the inside of the display region using equipotential lines. In the above-mentioned embodiment 1, the high voltage potential attenuation is achieved by the arrangement of the high-resistance film 18 and hence, an electric field in the vicinity of a trading end 171 of the metal back 17 becomes smooth as schematically indicated by the solid equipotential lines 19. As a result, the number of generation of discharge is drastically reduced thus realizing the acquisition of an image display device of long life time which exhibits excellent display quality. Here, equipotential lines 20 indicated by a dotted line in FIG. 5 are equipotential lines of the constitution where the high-resistance film 18 is not arranged.

### Embodiment 2

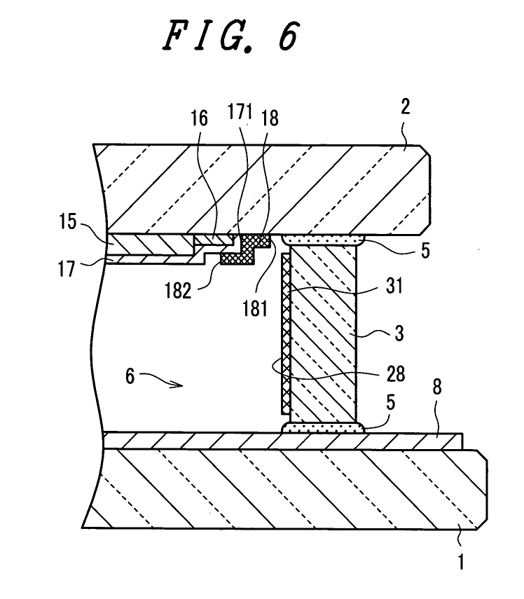

FIG. 6 is a schematic cross-sectional view showing another embodiment of the image display device of the present invention and corresponds to the above-mentioned FIG. 3. In FIG. 6, parts identical with the parts shown in the above-mentioned drawing are indicated by the same symbols.

In FIG. 6, numeral 28 indicates a high-resistance film. The high-resistance film 28 extends over the whole circumference of the frame body 3 and is arranged on an inner side surface 31 of the frame body 3 in a state that the high-resistance film 28 is not in contact with both substrates 1, 2. The high-resistance film 28 is formed of the same composition as the high-resistance film 18 arranged on a phosphor screen side and assumes the same resistance value as the high-resistance film 18 after the completion. A film thickness of the high-resistance film 28 is set to a value which falls within the size substantially equal to the size of the embodiment 1.

In the embodiment 2, by extending the second high-resistance film 28 over the whole circumference of the frame body 3 and by arranging the second high-resistance film 28 on the inner side surface 31 of the frame body 3 in addition to the high-resistance film 18 arranged on the phosphor screen side, the high voltage potential attenuation effect can be achieved. Accordingly, the inclination of equipotential lines 19 in the vicinity of a periphery 171 of the metal back 17 explained in conjunction with FIG. 5 becomes smoother than the above-mentioned embodiment 1 and hence, the number of discharge generation is drastically decreased thus enabling the acquisition of an image display device having a prolonged life time with the excellent display quality.

### Embodiment 3

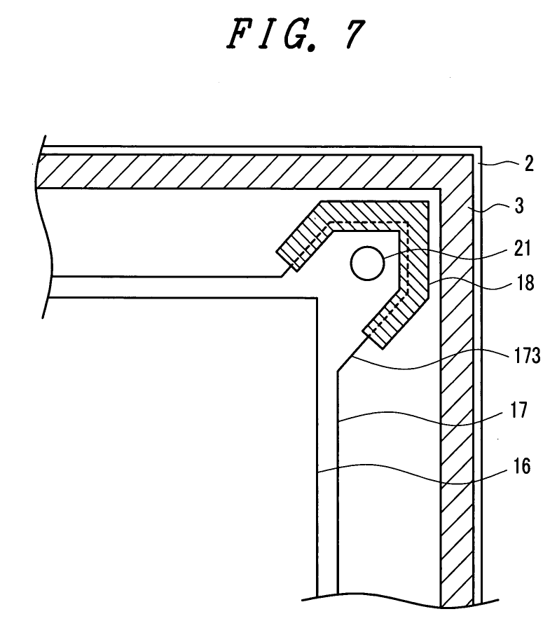

FIG. 7 is a schematic plan view for explaining still another embodiment of the image display device of the present invention, wherein parts identical with the parts shown in the above-mentioned drawing are indicated by the same symbols.

In FIG. 7, a metal back 17 extends to the vicinity of a frame body 3 at a corner portion thereof thus forming a projection portion 173. An anode-voltage lead terminal 21 is electrically connected with the metal back 17 at the projection portion 173 of the corner portion of the metal back 17. The anode-voltage lead terminal 21 is made of metal and is configured to extend from a back substrate 1 side. An anode voltage is supplied to the metal back 17 on a face substrate 2 from the back substrate 1 side via the anode-voltage lead terminal 21.

The projection portion 173 of the metal back 17 constitutes a high voltage supply portion of the face substrate 2 where an anode current is concentrated and hence, a potential is sharply changed particularly in a periphery of the projecting portion 173 out of the vicinity of an outer periphery of the metal back 17. In this embodiment 3, a high-resistance film 18 is formed outside the projecting portion 173 of the metal back 17 in a state that the high-resistance film 18 partially covers an outer peripheral portion of the projecting portion 173. In the constitution of this embodiment 3, due to the partial overlap structure which overlaps the high-resistance film 18 and a portion of a periphery of the metal back 17, it is possible to suppress a sharp potential change in the vicinity of the high voltage supply portion of the face substrate 2 and hence, the embodiment 3 can obtain the substantially same advantageous effects as the above-mentioned embodiments 1 and 2.

### Embodiment 4

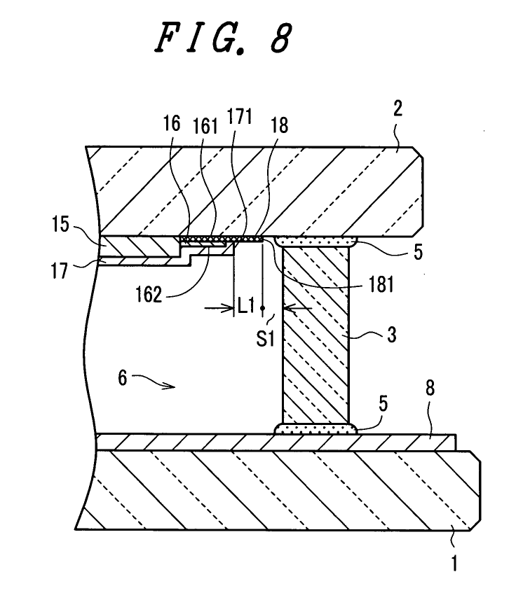

FIG. 8 is a schematic cross-sectional view for explaining still another embodiment of the image display device of the present invention, wherein parts identical with the parts shown in the above-mentioned drawing are indicated by the same symbols.

In FIG. 8, a BM film 16 is formed of the stacked structure which is constituted of a lower layer film 161 made of chromium oxide which is arranged below a glass surface of a face substrate 2 in contact with the glass surface and an upper layer film 162 formed of a chromium film which is arranged over the lower layer film 161.

In such a constitution, the lower layer film 161 made of chromium oxide is provided outside the upper layer film 162 formed of a chromium film which is arranged over the lower layer film 161, and further projects toward a frame body 3 side from a periphery 171 of the metal back 17, and a high voltage potential attenuation region is formed from the periphery 171 to a trading end 181. The respective film thicknesses, the respective projection sizes and the like are as described above.

According to this embodiment 4, the high-resistance film 18 can be formed simultaneously in a step for forming a BM film thus enhancing an operation efficiency in addition to an advantageous effects equal to the advantageous effect of the above-mentioned embodiments.

In the above-mentioned respective embodiments, the structure which uses an MIM type is exemplified as the electron sources. However, the present invention is not limited to such a structure and the present invention is applicable in the same manner also to a self-luminous FPD which uses the above-mentioned various electron sources.

What is claimed is:

1. An image display device comprising:
a back substrate which includes a plurality of scanning signal lines which extends in one direction and is arranged in parallel in the other direction orthogonal to the one direction, a plurality of video signal lines which extends in the other direction and is arranged in parallel in the one direction to intersect the scanning signal lines, an interlayer insulation film which is arranged between the video signal lines and the scanning signal lines, and electron sources which are arranged in the vicinity of respective intersecting portions of the scanning signal lines and the video signal lines,
a face substrate which includes phosphor layers which are provided corresponding to the electron sources and an acceleration electrode for accelerating electrons emitted from the electron sources toward the phosphor layers, and is arranged to face the back substrate in an opposed manner with a predetermined distance therebetween,
a frame body which is interposed between the back substrate and the face substrate while surrounding a display region and holds the predetermined distance, and
a sealing material which hermetically seals the frame body, the face substrate and the back substrate respectively in a sealing region, wherein
the image display device further includes a high resistance film which covers a periphery of the acceleration electrode and is arranged in a spaced apart manner from the frame body with a predetermined distance therebetween.

2. An image display device according to claim 1, wherein the high resistance film is arranged to cover the whole circumference of a periphery of the acceleration electrode.

3. An image display device according to claim 1, wherein the high resistance film is further arranged on an inner surface of the frame body at positions which are respectively spaced apart from the back substrate and the face substrate.

4. An image display device according to claim 1, wherein the high resistance film has a resistance value of 10¹⁰Ω/□ to 10¹⁴Ω/□.

5. An image display device according to claim 1, wherein an extension length of the high resistance film is 3 to 10 mm from a trailing end of the acceleration electrode.

6. An image display device according to claim 1, wherein the high resistance film contains insulating high resistance oxide.

7. An image display device according to claim 6, wherein the insulating high resistance oxide contains either of Fe₂O₃ and Cr₂O₃ as a main component.

8. An image display device according to claim 7, wherein the high resistance film contains 1 to 20% by weight of water glass.

9. An image display device according to claim 8, wherein the high resistance film contains the water glass at a mixing ratio between water glass and Fe₂O₃ or a mixing ratio between water glass and Cr₂O₃ which falls within a range of 1:4 to 1:10.

10. An image display device according to claim 1, wherein the high resistance film is made of conductive frit glass.

11. An image display device according to claim 10, wherein the high resistance film is made of conductive frit glass which contains vanadium oxide as a main component.

12. An image display device according to claim 11, wherein the high resistance film is made of conductive frit glass which further contains phosphorous oxide, antimony oxide or barium oxide.

13. An image display device according to claim 10, wherein the high resistance film includes silicon oxide or aluminum oxide as a filler.

14. An image display device according to claim 10, wherein a surface of the high resistance film has an average roughness Ra of 0.1 μm to 5 μm.

15. A manufacturing method of an image display device comprising:
a back substrate which includes a plurality of scanning signal lines which extends in one direction and is arranged in parallel in the other direction orthogonal to the one direction, a plurality of video signal lines which extends in the other direction and is arranged in parallel in the one direction to intersect the scanning signal lines, an interlayer insulation film which is arranged between the video signal lines and the scanning signal lines, and electron sources which are arranged in the vicinity of respective intersecting portions of the scanning signal lines and the video signal lines,
a face substrate which includes phosphor layers which are provided corresponding to the electron sources and an acceleration electrode for accelerating electrons emitted from the electron sources toward the phosphor layers, and is arranged to face the back substrate in an opposed manner with a predetermined distance therebetween,
a frame body which is interposed between the back substrate and the face substrate while surrounding a display region and holds the predetermined distance, and
a sealing material which hermetically seals the frame body, the face substrate and the back substrate respectively in a sealing region, wherein
a high resistance film which passes through a periphery of the acceleration electrode, extends in the frame body direction and is arranged in a spaced apart manner from the frame body with a predetermined distance therebetween is formed by sputtering using transitional metal oxide.
